(19) United States
(12) Patent Application Publication
(10) Pub. No.: US 2010/0118130 A1
(43) Pub. Date: May 13, 2010

(54) DIGITAL IMAGING SYSTEM

(76) Inventors: J. Keith Harris, Midland, MI (US); David A. Hayes, Midland, MI (US); Richard S. Harner, Midland, MI (US); William A. Heeschen, Midland, MI (US)

Correspondence Address: The Dow Chemical Company, Intellectual Property Section, P.O. Box 1967, Midland, MI, 48641-1967, US

(21) Appl. No.: 12/615,564

(22) Filed: Nov. 10, 2009

Related U.S. Application Data
(60) Provisional application No. 61/113,322, filed on Nov. 11, 2008.

(51) Int. Cl. H04N 7/18; G06K 9/00; H04N 5/33

(52) U.S. Cl. 348/61; 382/100; 348/E07.085; 348/E05.09; 348/164

(57) ABSTRACT

The invention is an image capturing device comprising a lens to capture the image of the one or more samples which are located in an image capturing chamber, a nest receptacle to hold the one or more samples during imaging, and at least one illuminating source to illuminate the one or more samples. The chamber, lighting and nest receptacle are configured to minimize undesired reflections and improve the image quality.

### CROSS-REFERENCE TO RELATED APPLICATION(S)

This application claims benefit of priority from U.S. Provisional Patent Application No. 61/113,322, filed Nov. 11, 2008, which application is incorporated by reference herein in its entirety.

### FIELD OF INVENTION

The present invention relates to a digital imaging system for image analysis of samples particularly in high throughput research.

### BACKGROUND OF THE INVENTION

High throughput research (sometimes also referred to as combinatorial) has become a wide practice nowadays especially in pharmaceutical and chemical industry to speed up the chemical discovery process and formulation research respectively. One aspect that is of interest in such research is the nature of samples as determined by visual or other optical inspection. The ability to view and analyze such mixtures in a high throughput context can be important.

WO 2004/053468 describes a combinatorial technique for systematically studying variations in heterogeneous mixtures such as oil-in-water and water-in-oil type of emulsions using automated and high throughput techniques. The system comprises a vial receptacle, an image capturing device, a light source directed at the first location and programmable processor operatively coupled to the image capturing device to detect a behavior in a captured image of a sample for analyzing a plurality of samples containing a dispersion of one or more incompletely miscible components in a continuous fluid phase. The device is available as the digital imaging feature of Symyx Technologies' Core Module tool.

### SUMMARY OF THE INVENTION

The inventors have discovered that the imaging quality of the Symyx tool is not always adequate to detect important features of the samples being investigated. They have now discovered an improved data image system.

Thus, in one aspect, the invention is a digital imaging device for analysis of one or more samples. The device comprises: an image capturing device comprising a lens to capture the image of the one or more samples which are located in an image capturing chamber, a nest receptacle to hold the one or more samples during imaging, and at least one illuminating source to illuminate the one or more samples. The digital image analysis system further comprises one or more features selected from the following: (a) at least one side of an inner surface of the image capturing chamber is a light absorbing non-reflective surface; (b) at least a first portion of the lens of the image capturing device is covered and a second portion exposed to the interior surface of the image capturing chamber to capture image; (c) the nest receptacle is provided with a spacer having through holes for the spacer to fit in vial nest pins to provide elevation of the samples in the vial nest receptacle; (d) the illuminating source is placed exterior to a housing containing the image capturing chamber which housing is opaque except for at least one aperture wherein the illuminating source is placed at an angle to illuminate the image capturing chamber through the aperture; (e) the illuminating source is placed exterior to a housing containing the image capturing chamber which housing is opaque except for at least one aperture wherein the aperture is fitted with a diffuser for diffusing the illuminating source, and (f) the light is directed at the sample at an angle of about 70 to 110 degrees relative to the lens and a reflective material is placed on the opposite side of the sample from the illuminating source and the reflective material is covered entirely by the sample.

A method of analyzing digital image(s) of plurality of samples using the digital image analysis system as described above was implemented by receiving the one or more samples in the image capturing chamber and placing the sample receptacles in a field view of the image capturing device and on the vial nest receptacle, illuminating the sample receptacles with at least one illuminating source and capturing the image. The image is processed digitally using computer interface to provide data on the samples. The digital image of the sample is analyzed using the digital image analysis system. Multiple sample mixtures such as liquid and emulsion samples can be prepared at one time, and these samples can be screened for desired properties in an automated high throughput manner.

Although the details of one or more embodiments of the invention are set forth in the accompanying drawings and the description below, other features, objects and advantages of the invention will be apparent from the description and drawings and from the claims.

### DESCRIPTIONS OF THE DRAWINGS

FIG. 1 illustrates a screening system according to a prior art.

FIG. 2 illustrates inside view of an image capturing chamber and components of an image capturing device of a digital imaging system according to prior art.

FIG. 3 illustrates a view inside an image capturing chamber of a digital imaging system, according to one embodiment of the present invention.

FIG. 4 shows a view of a top portion of the image capturing chamber according to one embodiment of the present invention having a diffusing lens and illuminating source.

FIG. 5 illustrates a view according to one embodiment of the present invention of the lens with the lens partly exposed to the inner surface of the image capturing chamber

FIG. 6 shows a view of a light diffusing lens according to one embodiment of the present invention

FIG. 7 shows a view of a vial nest receptacle according to one embodiment of the present invention with a vial spacer.

FIG. 8A shows a view of an exemplary digital image of a sample before implementing a light absorbing non-reflective surface.

FIG. 8B shows a view of a digital image of the sample after implementing a light absorbing non-reflective surface.

### DETAILED DESCRIPTION OF THE INVENTION

The system and methods described herein can be operated to employ rapid liquid handling and high throughput screening techniques to prepare and analyze libraries of samples for optically-detected characteristics. “Samples” as used in the present invention are preferably fluid mixtures in a liquid phase, including heterogeneous or homogenous mixtures. The term “heterogeneous mixtures” used in the present invention refers to liquid samples that have composition of two or more substances differing one from another that are not chemically combined with each other and are capable of being separated. In particular the term ‘emulsions’ or ‘liquid emulsions’ used herein refers to a suspension of tiny droplets of one liquid in a second liquid or mixing two liquids that ordinarily do not mix well. The liquid emulsion samples tend to display different optical characteristics of behavior when two immiscible liquids are mixed such as separated components, forming of layers or phases or bands. Although the system and apparatus used herein can be employed to analyze samples that are in liquid phase, they can also be used to prepare and analyze solid and gaseous mixtures and combinations of different phases such as solid suspensions in liquid, gels and colloidal systems and the like.

The samples are typically prepared in moveable containers such as vials or cuvettes, which collectively form the library where they are also held for analysis. The images of the samples are captured using the image capturing device and processed digitally using computer aided image processing techniques to provide qualitative and quantitative data about the samples. The digital image analysis of the samples can provide information about the phase separation, band forming or layer formation when two dissimilar liquid mixtures or emulsions are formed. Stages of demixing of the liquid samples can also be identified. One may be able to determine such information as volume fraction, optical density, stability of the mixture and the like.

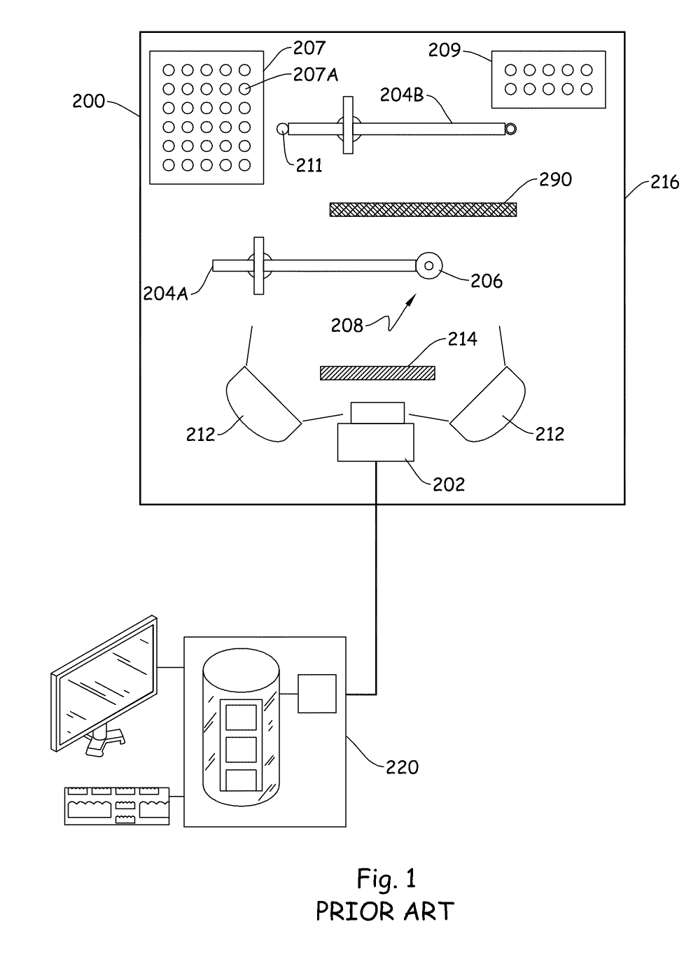

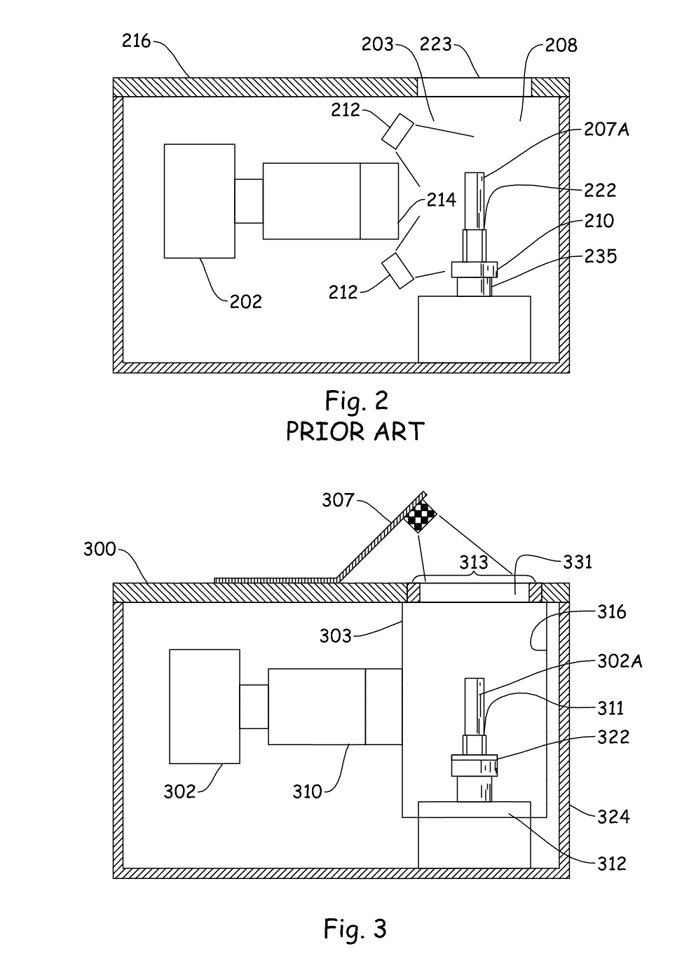

Referring to FIGS. 1 and 2, there is shown a prior art screening apparatus along with digital image system according to WO 04/053468 entitled “Image analysis of heterogenous mixtures” to analyze heterogeneous mixtures of samples for rapid and high throughput analysis. A screening apparatus 200 as illustrated in FIG. 1 comprises an image capturing device 202 such as a digital camera or single-lens reflex (SLR) camera or digital camera or with a color video camera such as MuTech color video camera or a charged-coupled device (CCD) capable of capturing digital images. The image captured by the digital camera will generally consist of sample receptacles containing samples.

The screening apparatus 200 includes one or more robotic arms 204A and 204B to facilitate high-throughput preparation and screening of the libraries of samples. At least one of the robotic arms 204A includes a vial gripper 206 to transport vials between a vial rack 207 and a location 208 that is within the field of view of digital camera 202. Vial gripper 206 is capable of picking, holding and releasing one or more vials when robotic arm 204 is transporting vials between vial rack 207 and location 208. As shown in FIG. 1 a back panel 290 can be mounted behind location 208, such that location 208 is positioned between back panel 290 and image capturing device 202. The mechanism of vial gripper 206 is driven by motorized or pneumatic methods. Other robotic arms 204B can be used to dispense components that are used to prepare the samples. For example, robotic arm 204B can aspirate components from a component rack 209, dispense the components into vials located in vial rack 207 and the components in the vials can then be mixed by a mixing apparatus 211. In the prior art, mixing apparatus 211 is located on robotic arm 204B.

As in FIG. 1, vial rack 207 is implemented to hold an array of vials 207a, each vial containing one of the samples to be analyzed. Vial rack 207 can be located within screening apparatus 200 to decrease the time required for robotic arm 204 to move vials into and out of location 208. The number of vials located within vial rack 207 varies based on the number of samples being analyzed. As mentioned above, robotic arm 204 positions sample vials at location 208 which can be situated at a focal point of the lens of digital camera 202.

One or more light sources 212 are positioned to illuminate vials positioned at location 208. This illuminating light is then reflected back into digital camera 202 to be captured in the form of a digital image. Two of light sources 212 are mounted on either side of digital camera 202. In this assembly, light sources 212 provide polarized light to illuminate vials and the samples contained therein.

Screening apparatus 200 as in FIG. 1 can also include a filter 214 such as a polarizing filter, mounted directly in front of the lens of digital camera 202 to eliminate unwanted light from the captured images.

The prior art screening apparatus 200 also includes computer system 220 which can be configured to control the operation of robotic arm 204, light sources 212, and digital camera 202.

Screening apparatus 200 includes a housing 216 that is configured to exclude light from the surroundings, such that stray or ambient light cannot affect the digital images captured by digital camera 202. Some or all of the elements described above can be located within housing 216. For example, the sample being analyzed, the light sources, and the camera optics are preferably located within housing 216, where they can be isolated from ambient light. By contrast, elements for which light exclusion is not crucial, such as computer system 220, vial rack 207, and robotic arm 204 can be, located outside of housing 216.

One example of the prior art invention is presented in FIG. 2 wherein an inner view of a location 208 is shown. This location includes a chamber which is an image capturing chamber (208) comprising an image capturing device 202 such as digital camera or video cameras for capturing the image of the samples. The resultant images that are captured by this device are the sample vials containing the liquid emulsions. The image capturing device 202 has the flexibility of receiving one or more accessories such as macro, zoom or other lenses for capturing images at different resolutions as needed or various filters intended to intensify or reduce various aspects of the optical signature. These accessories are normally provided by the supplier or optionally can be obtained separately from the markets.

The image capturing chamber 208 has an inner surface 218 and a vial nest receptacle 210 to receive the sample receptacle 207a for image analysis. The vial receptacle 210 has four vial pins 222 for the vials to rest in the vial nest receptacle. An image capturing chamber 208 of the prior art as illustrated in FIG. 2 also has a weighing device 235 such as weighing balance beneath the vial nest receptacle 210 for weighing the samples when placed in the vial nest receptacle 210. The image capturing chamber 208 has a pneumatically operated door 223 (not shown in FIG. 2) situated on the upper surface of the image capturing chamber to isolate the image capturing chamber from the external light.

The screening system 200 is generally used to analyze a library of samples. The term library used in this specification refers to any matrix of sites, having two or more members, with parametric diversity between members arranged in such a way that physical processes such as synthesis, characterization and measurements can be carried out. Each library includes two or more members, each of which may be represented as a region in an arrangement (an array) of one or more regions. It can also include such as any number of members for example two or more preferably, four, ten, twenty, hundreds or even thousands or more members. The vial rack 207 typically holds one or more members of the library for analysis within the screening system 200. The library design for a library of heterogeneous mixtures of liquid samples can be represented by a pie chart that displays the different components making up the sample. These library designs can be generated using computer implemented graphical design techniques. The output generated from the computer programs may include a list of mappings to be performed in preparing the library and will contain a recipe for each sample vial 207a that has to be prepared and analyzed in the digital image analysis system.

For digital image analysis of the sample vial 207a, the system obtains 207a containing the sample from vial rack 207 by liquid handling arms 204 and transports it into the image capturing chamber 208 through the pneumatically operated top door 223 and places it within the view of the image capturing device 202 to capture the digital image of the sample vial. The image thus obtained is in the form of an array or matrix of pixel values that corresponds to the intensity of the light reaching the lens system 214 of the image capturing device 202. Once the image of the vial 207a is captured, it is returned to the vial rack 207, the image is fed to the computer 220 for further analysis of the sample 207a. These digital images are used to generate qualitative and quantitative descriptions of the samples' natures which include parameters such as band heights and band intensities if banding layers are observed. This information can then be used to provide a detailed analysis of sample 207a.

Surprisingly the inventors have improved the data analysis system by using one or more image enhancement methods. Turning now to FIG. 3, there is shown an image analysis system 300 (FIG. 3) constructed in accordance with the present invention. According to a first embodiment, the inventors have provided a light absorbing, non-reflective surface on at least a portion of the inner surface and preferably the entire inner surface 316 of the image capturing chamber 303 as shown in FIG. 3. The light-absorbing non-reflective surface 316 can be of a surface coated with a matte, dark or light-absorbing finish. Alternatively, the interior may have a removable absorbing surface attached by gluing or by fastening means such as using a hook and pile type fastener to cover the inner surface of the image capturing chamber 303. The light absorbing non-reflective surface 316 preferably used according to the present invention is a black fabric either woven or non-woven type. Alternatively the light absorbing non-reflective covering 316 can be of black paper, or black card board of any ply thickness, or a black plastic sheet or a metal sheet or a black glass or a wooden board coated with black color. It is also possible to coat the inner sides of the image capturing chamber 316 with suitable non-reflective coating such as paint, or varnish or suitable black colors such as powder coating or electrochemical coating or spray painting.

According to a second embodiment of the present invention, the lens 310 of the image capturing device 302 is exposed partially through the light absorbing non-reflective surface 316 allowing very minimum portion of the lens 310 to be exposed inside the image capturing chamber 303 (FIGS. 3 and 5). The light absorbing non-reflective surface 316 has a narrow slit 317 opening as indicated in FIG. 5 that is covering the lens portion of the image capturing device 307 for minimum portion of the lens 310 to be exposed. The narrow slit opening in the non-reflective surface 316 according to one example such as a fabric cloth has a dimension corresponding to the length of the sample receptacle for capturing a sharp and clear image of the sample vial for further digital analysis.

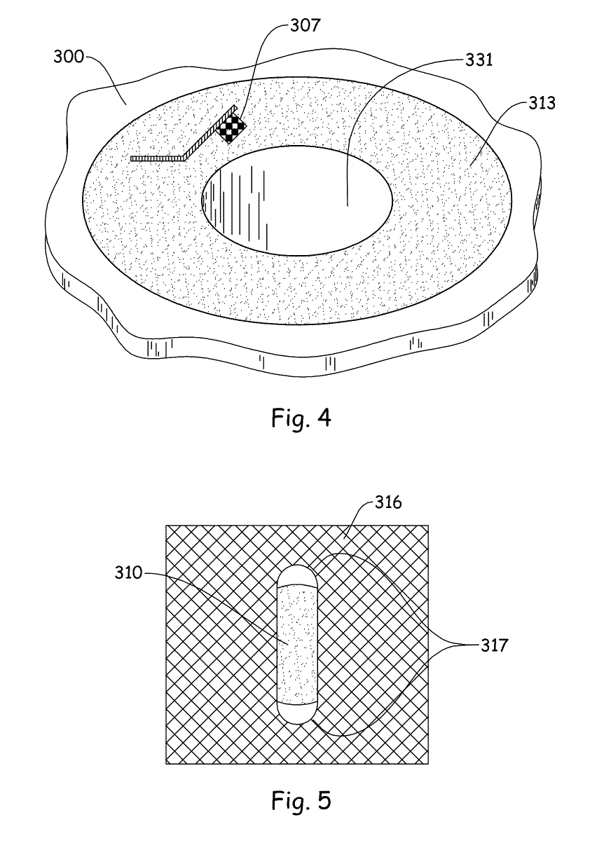

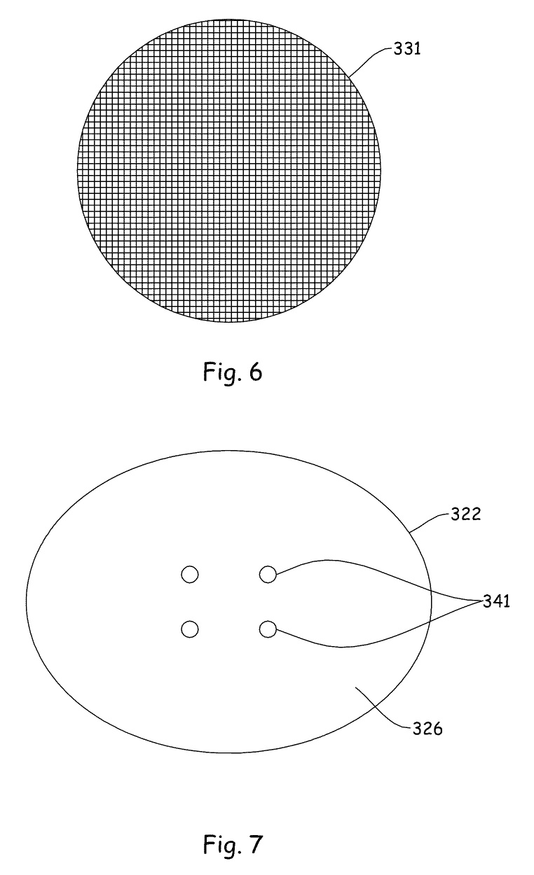

In additional embodiments of exemplary improvements in the digital image analysis system 300 according the present invention the light illuminating source is exterior to a housing which is opaque except for where there is an aperture. The light from the illuminating sources shines into the image capture chamber through the aperture and is further characterized by (1) the illuminating source is placed at an angle to the aperture rather than directly through the aperture and/or (2) the aperture includes a diffuser. FIG. 3 shows one such specific embodiment where the aperture is in a door to the chamber. However, a skilled worker would recognize that the aperture need not be in the door and the door need not be above the image capturing chamber. Thus the system 300 has the upper surface 323 of the image capturing chamber 303 in the housing 324 (shown in FIG. 3) fitted with a pneumatically operated door 313 and a light diffuser 331 fitting the opening of the door 313 as shown in FIG. 4 to diffuse light into the image capturing chamber 303. The light diffuser 331 diffuses light and provides an illuminating source into the image capturing chamber and sample vial. The light diffuser 331 is preferably circular in shape fitting exactly in the opening of the door 313. The light diffuser 331 as illustrated in FIG. 6 has a dimension ranging between 75-90 mm in diameter and more preferably 90 mm. The light diffuser 331 can be of glass or plastic or acrylic sheets and the like. Typically the light diffusers used for example are the ones that are used to diffuse white fluorescent light. The two illuminating light sources 212 as illustrated in prior art FIG. 1 are eliminated according to one aspect of the preferred embodiment of the present invention and provided with at least one light source 307 as illustrated in FIGS. 3 and 4 to provide illumination into the image capturing chamber 303. Preferably, the illuminating source 307 is fitted on the top portion near the door opening 313 at an oblique angle to illuminate the image capturing chamber (FIG. 4) The light source 307 can be of any type such as lamps, and more preferably of LED type comprising a 16 element white LED source. Optionally the light source 307 can be light selected from visible light, ultraviolet light and infrared light.

As shown in FIG. 3, the light is at an angle relative to the lens 310, the angle being between about 70 and 110 degrees and preferably 80 to 100 degrees and most preferably approximately a right angle. In addition, it is preferred that a reflective material be located on the opposite side of the sample from the incident light. Thus, in one preferred embodiment, a portion of the vial nest directly opposite from the incident light is painted white or covered with a highly reflective white coating and the rest of the vial nest is black. Preferably the incident light is from above and a white dot is added directly under the sample and is covered by the sample and the rest of the vial nest and spacer is black. This white dot reflects light upward through the sample from below and aids in distinguishing the interface between clear and opaque phases as well as increase the definition of the meniscus.

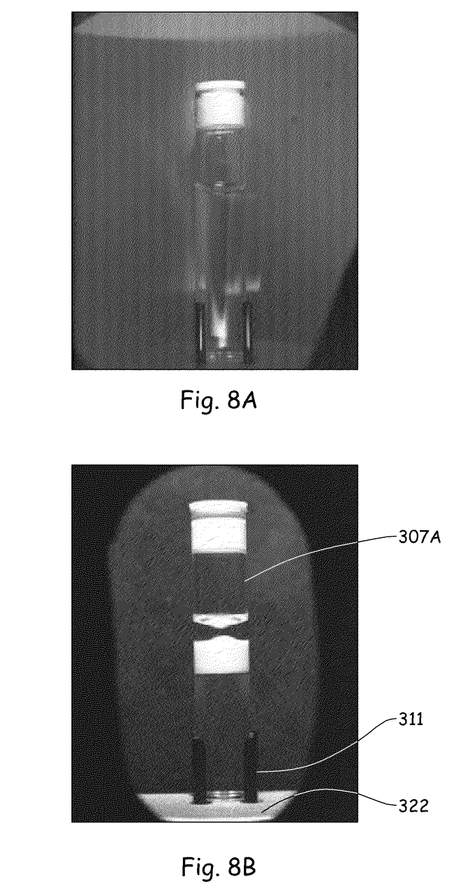

The image obtained prior to implementations of the preferred light absorbing non-reflective surface as illustrated in FIG. 8A was not complete and part of the base portion is not visible for thorough analysis of the sample.

Now, in a sixth embodiment, the inventors have found that providing a vial spacer 322 gives additional height for the sample vials 302a to be clearly visible in the image capturing device 302 as shown in FIG. 8B. The spacer has four holes 341 (FIG. 7) which can rest on the four vial pins 311 in the vial nest receptacle 310. The vial spacer 322 has a dimension ranging between 0.4-0.8 mm in diameter, more preferably about 0.6 mm in diameter, and a thickness of about 1-1.5 mm. The vial spacer 322 as illustrated in FIGS. 7 & 8B can be of any material such as a metal, plastic, cardboard, wood or any suitable material that provides additional height for the vial in the vial nest receptacle. Materials which reduce thermal transfer to the vial nest are advantageous. The vial spacer 322 can also be of any shape such as circular, square, rectangular, triangular. Specifically the vial spacer is a metal in the form of a disk.

The vial spacer 322 preferably has a light absorbing non-reflective surface 326 (FIG. 7). The surface optionally can be of any coating such as a black coating or powder coating or painting to avoid any reflection of the light from the illuminating source 302 inside the chamber. This helps in better image quality that can be captured by the image capturing device. The vial pins 311 also has a surface coated with non-reflective black coating and preferably the vial pins 311 have shrink sleeving or tubing such as with black polypropylene (PP), or polyvinylchloride (PVC) film or a black tubing made of rubber or silicone as illustrated in FIG. 9b to avoid any reflection from the illuminating source.

The image capturing chamber 303 optionally has a weighing device 312 such as a weighing balance. The weighing device 312 is placed at the base of the vial nest receptacle 310 where the sample vial 302a rests within the vial pins 311 attached to the vial nest receptacle for weighing the sample as shown in FIG. 3.

The digital image obtained from the image capturing device is generally in the form of a matrix with defined pixel values that correspond to the intensity of light reaching the lens of the image capturing device 302. The illumination and image capture can be automated through the computer interface using a computer program. Alternatively some or all of the illumination and image capture can be carried out based on manual interaction with a user. For example, the settings of the image capturing device 302 such as aperture, zoom, ISO speed, exposure time, and stored image quality, can be determined and adjusted by the image capture program using the computer interface. These settings can be adjusted to improve the image quality. In the present invention, the computer program is suitably modified to receive data and make adjustments on such items as frame rate, gain and exposure settings to receive better quality images of the sample. The image thus obtained by the improvements set forth in the above description can help in performing more accurate analysis of the sample.

Although the invention has been described in detail for the purpose of illustration, it is understood that such detail is solely for that purpose, and variations can be made therein by those skilled in the art without departing from the spirit and scope of the invention which is defined by the following claims.

What is claimed is:

1. A digital image analysis system for analyzing one or more samples comprising:
an image capturing device comprising a lens to capture the image of the one or more samples which are located in an image capture chamber;
a nest receptacle to hold the one or more samples during imaging;
at least one illuminating source to provide light on the one or more samples;
wherein the digital image analysis system further comprises features selected from at least one or more of the following comprising:
a) at least one side of an inner surface of the image capturing chamber is a light absorbing non-reflective surface;
b) at least a first portion of the lens of the image capturing device is covered and a second portion exposed to the interior of the image capturing chamber;
c) the nest receptacle is provided with a spacer having through holes for the spacer to fit in vial nest pins to provide elevation of the samples in the vial nest receptacle;
d) the illuminating source is placed exterior to a housing containing the image capturing chamber which housing is opaque except for at least one aperture wherein the illuminating source is placed at an angle to illuminate the image capturing chamber through the aperture;
(e) the illuminating source is placed exterior to a housing containing the image capturing chamber which housing is opaque except for at least one aperture wherein the aperture is fitted with a diffuser for diffusing the illuminating source; and
(f) the light is directed at the one or more samples at an angle of about 70 to 110 degrees relative to the lens and a reflective material is placed on the opposite side of the sample from the incident light and is covered by the sample.

2. A digital image analysis system as claimed in claim 1 wherein the inner surface of the image capturing chamber is at least six sided.

3. A digital image analysis system as claimed in claim 1 wherein the inner surface of the image capturing chamber is cylindrical.

4. A digital image analysis system as claimed in claim 1 wherein the image capturing device captures images of individual samples.

5. A digital image analysis system as claimed in claim 1 further comprising an automated sample handling system coupled to a programmable processor configured to transport sample receptacle to and from the image capturing chamber.

6. A digital image analysis system as claimed in claim 1 wherein the sample to be analyzed is a heterogeneous mixture.

7. A digital image analysis system as claimed in claim 1 wherein the sample to be analyzed is a homogeneous mixture.

8. A digital image analysis system as claimed in claim 6 wherein the heterogeneous mixture is an emulsion.

9. A digital image analysis system as claimed in claim 8 wherein the emulsion is a water-in-oil type emulsion.

10. A digital image analysis system as claimed in claim 1 wherein the light absorbing non-reflective inner surface is formed from materials selected from the group consisting of woven or non-woven fabrics, paper board, plastic sheets or films, coating materials, or paints.

11. A digital image analysis system as claimed in claim 1 wherein the light absorbing non-reflective surface is black.

12. A digital image analysis system as claimed in claim 1 wherein the spacer present in the nest receptacle is selected from the group consisting of metal, plastic, cardboard, wood, laminated glass, acrylic sheets.

13. A digital image analysis system as claimed in claim 1 wherein the spacer is preferably a metal ring.

14. A digital image analysis system as claimed in claim 1 wherein the spacer has at least one surface with a light absorbing non-reflective surface

15. A digital image analysis system as claimed in claim 1 wherein the illuminating source diffuser is selected from materials such as transparent plastic, and glass sheets.

16. A digital image analysis system as claimed in claim 15 wherein the illuminating source diffuser is preferably an acrylic sheet.

17. A digital image analysis system as claimed in claim 1 wherein a surface of the vial nest pins is a light-absorbing non-reflective surface.

18. A digital image analysis system as claimed in claim 1 wherein the illuminating source is a light source selected from the group consisting of visible light, ultraviolet light, and infrared light.

19. A method of analyzing digital images of one or more samples using the improved digital image analysis system of claim 1 comprising;
receiving the one or more samples in the image capturing chamber placing the sample receptacles in a field of view of the image capturing device and on the vial nest receptacle;
illuminating the sample receptacles with at least one light source;
capturing an image at an oblique angle relative to the source light;
processing the image digitally using a computer interface to provide data on the samples;
analyzing the digital image of the plurality of heterogeneous sample mixtures using a digital image analysis system.
